(19) United States
(12) Patent Application Publication
(10) Pub. No.: US 2025/0208592 A1
(43) Pub. Date: Jun. 26, 2025

(54) METHOD AND APPARATUS FOR CONTROLLING PRODUCTION LINES BASED ON PRODUCT DEMAND FORECASTING THROUGH DECOMPOSITION TECHNIQUE AND HYBRID MACHINE LEARNING MODEL

(71) Applicant: Impactive AI.Inc, Pohang-si (KR)

(72) Inventors: Doo Hee CHUNG, Pohang-si (KR); Joo Young HA, Pohang-si (KR); Sung Won LEE, Seoul (KR)

(21) Appl. No.: 19/080,922

(22) Filed: Mar. 16, 2025

Related U.S. Application Data
(63) Continuation-in-part of application No. 18/811,922, filed on Aug. 22, 2024.

(30) Foreign Application Priority Data
Oct. 23, 2023 (KR) 10-2023-0142372

(51) Int. Cl. G05B 13/04; G05B 13/02

(52) U.S. Cl. CPC G05B 13/048; G05B 13/0265

(57) ABSTRACT

A method for controlling production lines based on product demand forecasting. The method includes constructing a first model that decomposes time series data into eIMF and a residual based on an EEMD algorithm, constructing a second model that extracts a key variable from the eIMF based on a LASSO algorithm, constructing a third model that performs demand forecasting by inputting the key variable into a machine learning model, inputting original data into the first model to decompose the original data into at least one eIMF and a residual, inputting the eIMF decomposed in the first model into the second model to extract the key variable, inputting the key variable extracted from the second model into the third model to forecast demand, and transmitting a control signal to the production lines, such that a production volume of at least one product is controlled based on the forecasted demand.

### CROSS-REFERENCE TO RELATED APPLICATIONS

This is a continuation in part application claiming priority from U.S. Non-Provisional patent application Ser. No. 18/811,922, filed on Aug. 22, 2024, the entire contents of which are hereby incorporated by reference.

### TECHNICAL FIELD

The present disclosure relates to a method and an apparatus for controlling production lines based on product demand forecasting through decomposition technique and hybrid machine learning model that combine multiple models to build a hybrid model in order to improve time series-based forecast performance and utilize the hybrid model to forecast demand for a product.

### BACKGROUND

Accurately forecasting future time-series demand is an important task that allows companies to make more favorable choices in decision-making situations and increase their competitive advantage. Conventionally, various corporate and market data are collected and analyzed to make decisions related to resource planning, product development, and marketing strategy optimization. Since forecast accuracy plays an important role in improving the quality of such decisions, selecting the right forecast technique is important. Conventionally, demand forecasting is mainly performed using time-series analysis and traditional statistical methods, but the limitations of these methods have been constantly raised due to the irregular demand data of modern companies and the irregularity of the market.

In order to cope with the limitations of unstructured and irregular data and complex market environments, advanced data science forecasting techniques have been applied recently, and deep learning models are being applied to forecast product sales volume. However, these models still cannot sufficiently handle the complexity and volatility of the market, so they are focusing on developing hybrid models that strategically integrate multiple models to create superior performance. The hybrid models are motivated by combining the strengths of different models to create synergy or overcoming the shortcomings of a specific model. Existing hybrid models present superior forecasting effects compared to general machine learning single models, but advanced hybrid models based on data science have not been proposed in various ways yet, and thus, advanced hybrid models for more ideal demand forecasting methods are needed.

As a related patent, Korean Patent No. 10-2560263 (electric power forecast device using mode decomposition and neural network) is disclosed. However, in Korean Patent No. 10-2560263, original data for analysis or forecast from the entire power demand data is set, and only a mode decompose unit that performs mode decomposition on the original data, a neural network unit that performs learning or forecasting using the mode decomposed by the mode decomposition unit, and a mode synthesis unit that synthesizes forecast data of the mode produced by the neural network unit are described.

### SUMMARY

The problem to be solved by the present disclosure is to solve the problems of the above-mentioned conventional technology, and an object of the present disclosure is to provide a method and an apparatus for controlling production lines based on product demand forecasting using a machine learning-based hybrid model capable of forecasting product demand through a hybrid model by constructing a model for decomposing time series data into eIMF and residue based on a decomposition algorithm including at least one of EEMD, EMD, and CEEMDAN, constructing a model for extracting a key variable from eIMF based on a LASSO algorithm including at least one of Elastic-net, Ridge, and SHAPT, and constructing a model for performing demand forecasting by inputting the key variables into a machine learning model.

According to an aspect of the present disclosure, there is provided a method for controlling production lines based on product demand forecasting using a decomposition technique and a machine learning hybrid model, the method including: constructing a first model that decomposes time series data into at least one eIMF (ensemble IMF) and a residual based on a decomposition algorithm including at least one of EEMD (Ensemble Empirical Mode Decomposition), EMD (Empirical Mode Decomposition), and CEEMDAN (Complete Ensemble Empirical Mode Decomposition); constructing a second model that extracts a key variable from the eIMF based on a LASSO algorithm including at least one of Elastic-net, Ridge, and SHAP; constructing a third model that performs demand forecasting by inputting the key variable into a machine learning model; inputting original data into the first model to decompose the original data into at least one eIMF and a residual; inputting the eIMF decomposed in the first model into the second model to extract the key variable; inputting the key variable extracted from the second model into the third model to forecast demand; and transmitting a control signal to the production lines based on the forecasted demand, such that a production volume of at least one product is directly controlled, in real time, based on the forecasted demand.

According to another aspect of the present disclosure, there is provided an apparatus for controlling production lines based on product demand forecasting using a decomposition technique and a machine learning hybrid model, the apparatus including a processor and one or more memory devices communicatively coupled to the processor, and the one or more memory devices stores instructions operable when executed by the processor to perform: constructing a first model that decomposes time series data into at least one eIMF (ensemble IMF) and a residual based on a decomposition algorithm including at least one of EEMD (Ensemble Empirical Mode Decomposition), EMD (Empirical Mode Decomposition), and CEEMDAN (Complete Ensemble Empirical Mode Decomposition); constructing a second model that extracts a key variable from the eIMF based on a LASSO algorithm including at least one of Elastic-net, Ridge, and SHAP; constructing a third model that performs demand forecasting by inputting the key variable into a machine learning model; inputting original data into the first model to decompose the original data into at least one eIMF and a residual; inputting the eIMF decomposed in the first model into a second model to extract the key variable; inputting the key variable extracted from the second model into a third model to forecast demand; and transmitting a control signal to the production lines based on the forecasted demand, such that a production volume of at least one product is directly controlled, in real time, based on the forecasted demand.

### ADVANTAGEOUS EFFECTS

According to the present disclosure, the production volume of a product can be efficiently controlled, in real time, based on the product demand forecasting.

According to the present disclosure, it is possible to construct the first model that decomposes the time series data into the eIMF and the residue based on a decomposition algorithm including at least one of EEMD, EMD, and CEEMDAN.

According to the present disclosure, it is possible to construct the second model that extracts the key variable from eIMF decomposed from the first model based on the LASSO algorithm including at least one of the Elastic-net, the Ridge, and the SHAP.

According to the present disclosure, it is possible to construct the third model that performs demand forecasting by inputting the key variable extracted from the second model into the machine learning model.

According to the present disclosure, it is possible to forecast the product demand through the hybrid model by inputting original data.

### BRIEF DESCRIPTION OF THE DRAWINGS

FIG. 1 is a flowchart illustrating a method for controlling production lines based on a product demand forecasting using a decomposition technique and a machine learning hybrid model according to one embodiment of the present disclosure.

FIG. 2 is a configuration diagram illustrating the product demand forecasting device using a decomposition technique and a machine learning hybrid model according to one embodiment of the present disclosure.

FIG. 3 illustrates a framework of an LSTM model according to one embodiment of the present disclosure.

FIGS. 4 and 5 illustrate an optimized hyperparameter according to one embodiment of the present disclosure.

FIG. 6 illustrates a result of EEMD decomposition of an office product A that proceeds according to a framework of EEMD+LASSO+LSTM model according to one embodiment of the present disclosure.

FIG. 7 illustrates a result measured by total of three evaluation indices, NRMSE, NMAE, and R² according to one embodiment of the present disclosure.

FIG. 8 illustrates a graph of eIMF of the office product A according to one embodiment of the present disclosure.

FIG. 9 illustrates a graph of eIMF of a packaging material B according to one embodiment of the present disclosure.

FIG. 10 illustrates a graph of eIMF of a pharmaceutical product C according to one embodiment of the present disclosure.

FIG. 11 illustrates a graph of predicted and actual values of the office product A according to one embodiment of the present disclosure.

FIG. 12 illustrates a graph of the predicted and actual values of the packaging material B according to one embodiment of the present disclosure.

FIG. 13 illustrates a graph of the predicted-actual values of the pharmaceutical product C according to one embodiment of the present disclosure.

FIG. 14 is a block diagram of an apparatus for controlling production lines based on the product demand forecasting according to one embodiment of the present disclosure.

### DETAILED DESCRIPTION OF EXEMPLARY EMBODIMENTS

This specification may use the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” may refer to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, an Apache MXNet framework, or etc.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Since a technology described below may have various modifications and various embodiments, specific embodiments will be illustrated in the accompanying figures and described in detail. However, it should be understood that the below descriptions include all modifications, equivalents or substitutes which belong to the ideas and the scope of the described technology. A specific structural or functional description of embodiments according to the concept of the present disclosure disclosed in the present specification is merely exemplified for the purpose of illustrating embodiments according to the concept of the present disclosure, and embodiments according to the concept of the present disclosure may be implemented in various forms and are not limited to embodiments described in the present specification.

Since embodiments according to the concept of the present disclosure may have various changes and may have various forms, embodiments are illustrated in the drawings and described in detail in the present specification. However, this is not intended to limit embodiments according to the concept of the present disclosure to specific disclosed forms, and includes all modifications, equivalents, or substitutes included in the spirit and technical scope of the present disclosure.

The terms used in the present specification are only used to describe specific embodiments and are not intended to limit the present disclosure. The singular expression includes the plural expression unless the context clearly indicates otherwise. In the present specification, the terms “include”, “have”, or the like are intended to specify the presence of a feature, number, step, operation, component, part, or combination thereof described in the present specification, and should be understood as not excluding in advance the possibility of the presence or addition of one or more other features, numbers, steps, operations, components, parts, or combinations thereof.

Hereinafter, embodiments of the present disclosure will be described in detail with reference to the drawings attached to the present specification.

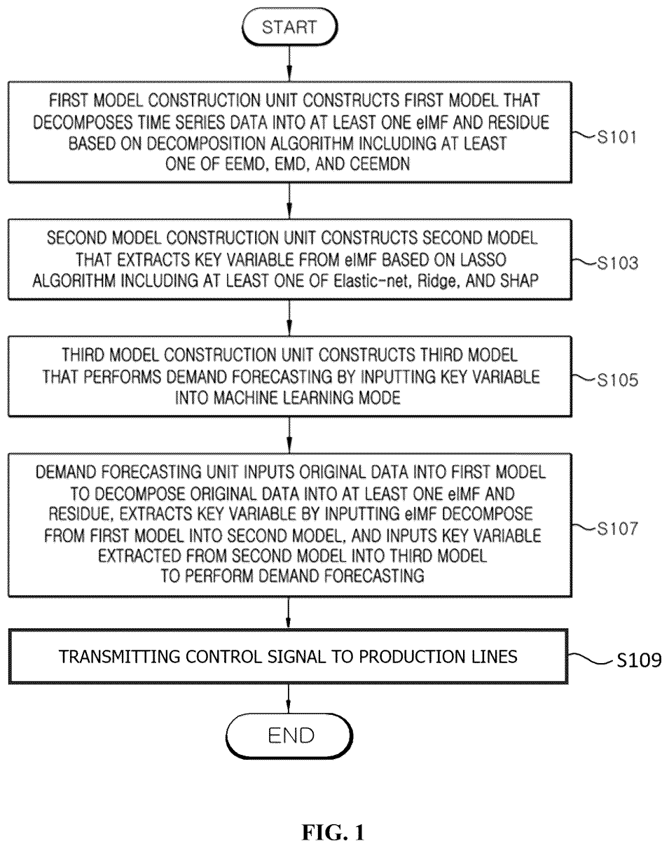

FIG. 1 is a flow chart illustrating a method for controlling production lines based on a product demand forecasting method using a decomposition technique and a machine learning hybrid model according to one embodiment of the present disclosure. As described above, the various unit of exemplary embodiments (described hereafter) can be implemented as one or more computer programs, i.e., one or more units of computer program instructions encoded on a tangible non transitory storage medium for execution by, or to control the operation of, data processing apparatus.

Referring to FIG. 1, a first model construction unit 110 constructs a first model that decomposes time series data into at least one eIMF and residue based on a decomposition algorithm including at least one of EEMD, EMD, and CEEMDN (S101). The EEMD (Ensemble Empirical Mode Decomposition) is one of the methods used to analyze time series data, and is based on the assumption that any signal consists of several IMFs (Intrinsic Mode Functions). The EEMD is an ensemble methodology that alleviates a mode mixing problem, which is a limitation of the existing EMD (Empirical Mode Decomposition). In the EEMD, Gaussian white noise is added to the original data, EMD is applied n times, and then each result is ensembled to finally extract eIMF (ensemble IMF). The EEMD is particularly useful for analyzing nonlinear and nonstationary time series data, and this technique can decompose complex data into several simple functions.

EMD analyzes the original series graph by decomposing the original series graph into n IMFs. However, the EMD method has a disadvantage in that mode mixing occurs. The mode mixing is a phenomenon that generally occurs in the process of decomposing a signal, and means that multiple components of the signal are intricately entangled. When the mode mixing occurs, multiple frequency components of the signal are not accurately separated, and thus, each IMF does not accurately represent a single frequency component. Therefore, this phenomenon makes the physical interpretation of the IMF difficult and reduces the accuracy of the time-frequency representation. This irregularity not only causes serious aliasing in the time-frequency distribution, but also obscures the physical meaning of each IMF. To solve this problem, the EEMD decompose technique that performs the EMD by adding small probabilistic noise to the input signal can be used.

A second model construction unit 120 constructs a second model that extracts key variables from the eIMF based on an LASSO algorithm including at least one of Elastic-net, Ridge, and SHAP (S103). The LASSO algorithm is a regularization method that simultaneously performs parameter estimation and variable selection by minimizing the sum of squares of residues like the least squares method and limiting the absolute size of coefficients.

A third model construction unit 130 constructs a third model that performs demand forecasting by inputting the key variable into a machine learning model (S105). The machine learning model may be at least one of LSTM (Long Short-Term Memory), Qboost, LGBM, XGboost, Catboost, Random forest, ANN, DNN, LSTM, SVM, ARIMA, SARIMA, and PROPHET models, and although the present disclosure is described based on the LSTM model, the present disclosure is not necessarily limited thereto. The LSTM model is an improved model that overcomes the limitations of the existing recurrent neural network (RNN) model, and is designed to solve the long-term dependency problem of RNN.

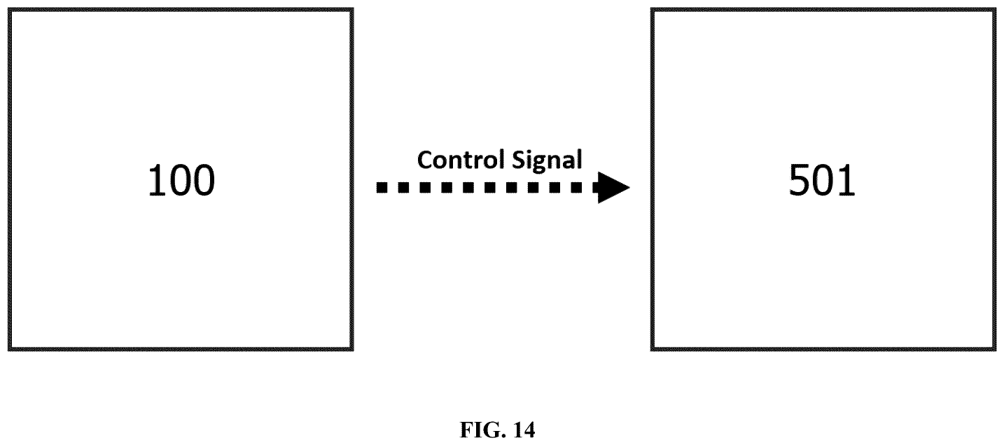

A demand forecasting unit 140 inputs original data into the first model constructed by the first model construction unit 110 to decompose the original data into at least one eIMF and residue, extracts the key variable by inputting the eIMF decomposed from the first model into the second model constructed by the second model construction unit 120, and inputs the key variable extracted from the second model into the third model constructed by the third model construction unit 130 to perform demand forecasting (S107). The data decomposed through EEMD in the first model may still contain important characteristics and unnecessary variables. To solve this problem, the second model is used to introduce LASSO regression. When the number of independent variables is large in the process of forecasting demand, the performance of the model may actually deteriorate. Problems such as overfitting, increased computational complexity, and multicollinearity arise. Therefore, the procedure for precisely identifying the connection between variables in high-dimensional data and effectively selecting main explanatory variables is emphasized. The original data is time series data in which preprocessing and feature engineering of product demand data have been performed in advance, and is data prepared for model learning by extracting product demand data by item for time series modeling. Referring now also to FIG. 14, according to an exemplary embodiment, a control signal is transmitted from the product demand forecasting device 100 to the production lines 501 based on the forecasted demand (S109), such that a production volume of at least one product is directly controlled, in real time, based on the forecasted demand.

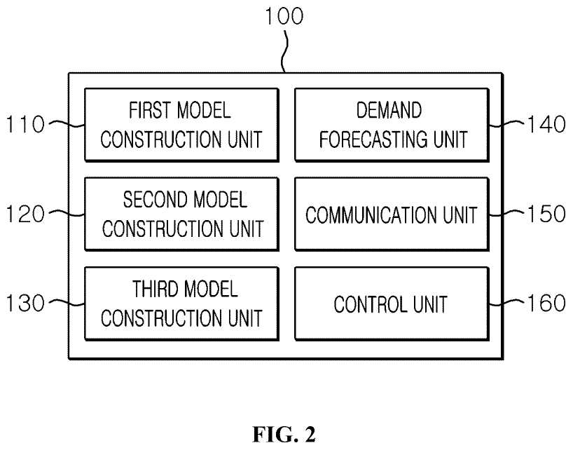

FIG. 2 is a configuration diagram illustrating the product demand forecasting device using a decomposition technique and a machine learning hybrid model according to one embodiment of the present disclosure.

Referring to FIG. 2, the product demand forecasting device 100 using a decomposition technique and a machine learning hybrid model includes the first model construction unit 110, the second model construction unit 120, the third model construction unit 130, the demand forecasting unit 140, a communication unit 150, and a control unit 160.

The first model construction unit 110 can build a first model that decomposes the time series data into at least one eIMF (ensemble IMF) and residue based on the decomposition algorithm including at least one of the EEMD (Ensemble Empirical Mode Decomposition), the EMD (Empirical Mode Decomposition), and the CEEMDN (Complete Ensemble Empirical Mode Decomposition). The EEMD algorithm is one of the methods used to analyze time series data, and is based on the assumption that any signal is composed of several IMFs (Intrinsic Mode Functions). The EEMD algorithm can add Gaussian white noise to time series data, apply n EMDs, and ensemble each result to finally extract the eIMF. In addition, the EEMD algorithm is particularly useful for analyzing nonlinear and non-stationary time series data, and can decompose complex data into multiple simple functions through this algorithm. The core principle of the EEMD algorithm is to add Gaussian white noise to the original data and divide this evenly into IMFs with only various frequency characteristics. In the decomposition process where each noise is added, the result with white noise added to the signal is derived, so the result containing noise is derived. At this time, since the noise of each experiment is independent, the noise can be reduced or completely canceled by taking the average of the results of multiple experiments. Therefore, when the average of the ensemble is taken, the noise gradually disappears and only the original signal remains.

The first model of the first model construction unit 110 sets the number of ensembles to be performed in the EEMD algorithm and the standard deviation of the Gaussian white noise to be added to the time series data, and can add noise to the time series data.

$${x}_{m} ( t ) = x ( t ) + {n}_{m} ( t ) \qquad [ Expression 1 ]$$

The expression for adding the noise to the time series data is as illustrated in [Expression 1], where x(t) is the original time series data, nₘ(t) is the Gaussian white noise, xₘ(t) is the signal to which noise is added to the original time series data, and m is the number of ensembles. The first model can decompose xₘ(t) which is the signal with added noise into I IMFs, and can add noise while changing the noise nₘ(t) during the number of ensembles (m). In other words, the first model can generate the signal with added noise obtained by adding white noise to the original time series data according to the set number of ensembles. The first model can extract at least one IMF from each signal xₘ(t) with added noise, calculate an ensemble average of the IMFs executed during the target number M, and extract the average value of the ensemble as the final ensemble IMF (eIMF), as illustrated in [Expression 2] below.

$${c}_{i} = \frac{1}{M} {\sum }_{m = 1}^{M} {c}_{i , m} , i = 1 , 2 , … , I , m = 1 , 2 , … , M \qquad [ Expression 2 ]$$

Here, c_{i,m} represents the i-th IMF of the m-th test, and I can mean the number of IMFs. The first model can define a remainder after subtracting eIMFs from the original time series data as the residue.

The second model construction unit 120 can build a second model that extracts the key variables from the eIMFs based on a LASSO (Least Absolute Shrinkage and Selection Operator) algorithm that includes at least one of the Elastic-net, Ridge, and SHAP. The LASSO algorithm is a regularization method that simultaneously performs parameter estimation and variable selection by minimizing the sum of squares of residues like the least squares method and limiting the absolute size of coefficients.

$${\hat{β}}^{lasso} = arg {min}_{β} \{ \frac{1}{2} {\sum }_{i = 1}^{N} {( {y}_{i} - {β}_{0} - {\sum }_{j = 1}^{p} {x}_{ij} {β}_{j} )}^{2} + λ {\sum }_{j = 1}^{p} \vert {β}_{j} \vert \} \qquad [ Expression 3 ]$$

[Expression 3] is an expression representing the model of the LASSO algorithm, where N represents the number of data, p represents the number of features, y represents the dependent variable (demand), and β can represent the weight (regression coefficient of the feature). The LASSO algorithm can use a penalty function based on L1 regularization that minimizes the sum of the absolute values of the coefficients. Each coefficient decreases according to the size of the constant λ, and in this process, the coefficient approaches 0. Accordingly, intuitive feature selection is possible, so that some coefficients become 0 depending on the size of λ, and unnecessary variables can be excluded from the model. The second model can select the key variable for each eIMF through the LASSO algorithm. The LASSO and Ridge are one of the regression coefficient reduction methods, and Elastic-Net can be a hybrid regression model of Lasso and Ridge. The SHAP refers to a methodology that combines Shapley Value and LIME used in game theory.

The third model construction unit 130 can construct the third model that performs demand forecasting by inputting the key variable into the machine learning model. The machine learning model may be at least one of LSTM (Long Short-Term Memory), Qboost, LGBM, XGboost, Catboost, Random forest, ANN, DNN, LSTM, SVM, ARIMA, SARIMA, and PROPHET models, and the present disclosure is based on the LSTM model, but the present disclosure is not necessarily limited thereto. The LSTM model is an improved model that overcomes the limitations of the existing recurrent neural network (RNN) model, and is designed to solve the long-term dependency problem of RNN. The structure of LSTM includes a forget gate, an input gate, and an output gate. The forget gate removes unnecessary past information, the input gate remembers current information, and the output gate determines the information to be output. The operation of LSTM depends on two main states, namely, a hidden layer state and a cell state. The hidden layer state contains information that the model should remember in the short term, and the cell state stores long-term information. Due to the introduction of the cell state, LSTM effectively solves the long-term dependency problem and is capable of learning complex sequence data.

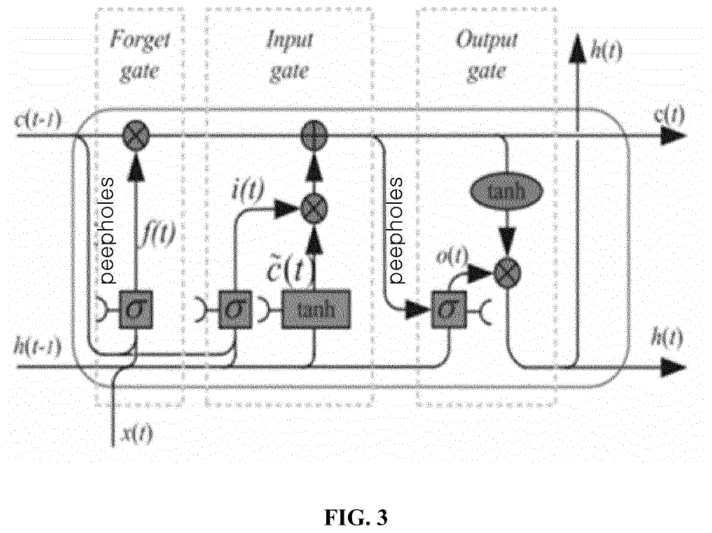

FIG. 3 illustrates the framework of the LSTM model according to one embodiment of the present disclosure, and referring to FIG. 3 together, three gate units such as the input gate, the output gate, and the forget gate are used in the LSTM unit to control information transfer. In general, time series data of each time step and the previous hidden layer state are used as inputs of the LSTM unit. The input gate iₜ controls how much information [symbol] which is the candidate state of the current time step should be stored. The forget gate fₜ controls what information to delete from the internal state cₜ₋₁ of the previous time step. The output gate oₜ determines the amount of information to be transferred from the internal state cₜ to the external state hₜ of the current time step. The recurrent cell structure inside the LSTM network calculates the input gate, the output gate, the forget gate, and the candidate state from the external state hₜ₋₁ of the previous time step and the current time step xₜ. After that, the memory cell cₜ is updated and the forget gate fₜ and the input gate iₜ are combined to update. After that, the output gate oₜ is combined to transfer the internal state information to the external state hₜ. The LSTM accumulates important feature information during the time series data processing and makes maximum use of existing data through the backpropagation process during time series data processing corresponding to the LSTM update Equation.

$${i}_{t} = σ ( {W}_{i} {x}_{t} + {U}_{i} {h}_{t - 1} + {b}_{i} ) \qquad [ Expression 4 ]$$

$${f}_{t} = σ ( {W}_{f} {x}_{t} + {U}_{f} {h}_{t - 1} + {b}_{f} ) \qquad [ Expression 5 ]$$

$${o}_{t} = σ ( {W}_{o} {x}_{t} + {U}_{o} {h}_{t - 1} + {b}_{o} ) \qquad [ Expression 6 ]$$

$${c}_{t} = {f}_{t} ⊙ {c}_{t - 1} + {i}_{t} ⊙ \tilde{{c}_{t}} \qquad [ Expression 7 ]$$

$${h}_{t} = {o}_{t} ⊙ tanh ( {c}_{t} ) \qquad [ Expression 8 ]$$

$${h}_{t} = {o}_{t} ⊙ tanh ( {c}_{t} ) \qquad [ Expression 9 ]$$

[Expressions 4] to [Expressions 9] represent calculation expressions in the recurrent cell structure within the LSTM network, where xₜ is the input vector at time t, iₜ is the input gate, oₜ is the output gate, fₜ is the forget gate, σ is the sigmoid function, W is the weight matrix, b is the bias matrix, h is the hidden layer state vector, [symbol] is an input memory cell vector, and cₜ is a cell state vector. Through the processing process, the LSTM can learn specific patterns from input data and solve the long-term dependency problem of data to generate better forecast performance.

The demand forecasting unit 140 inputs original data into the first model constructed by the first model construction unit 110 to decompose the original data into at least one eIMF and residue, inputs the eIMF decomposed from the first model into the second model constructed by the second model construction unit 120 to extract the key variable, and inputs the key variable extracted from the second model into the third model constructed by the third model construction unit 130 to forecast the demand. The original data may be the time series data in which preprocessing and feature engineering of product demand data have been performed in advance, and may be data prepared for model learning by extracting product demand data by item for time series modeling, but the present disclosure is not necessarily limited thereto.

The communication unit 150 can perform network communication with other network devices, and can receive data required for modeling data and information for studying a high-quality forecast model. The network includes a local area network (LAN), a wide area network (WAN), a value-added network (VAN), a mobile radio communication network, a satellite communication network, and a combination thereof. The network is a comprehensive data communication network, and can include wired Internet, wireless Internet, and mobile radio communication networks. In addition, the wireless communication can include, but is not limited to, wireless LAN (Wi-Fi), Bluetooth, Bluetooth low energy, Zigbee, WFD (Wi-Fi Direct), UWB (ultra wideband), infrared communication (IrDA, infrared Data Association), NFC (Near Field Communication), or the like, for example.

The control unit 160 controls the processing of processes related to constructing the first model, second model, and third model, and controls the operation of each configuration.

Below is an example of an experiment using data from three different industries to verify the effectiveness of the product demand forecasting using a decomposition technique and machine learning hybrid model of the present disclosure. The three industries are an office product, a packaging material, and a pharmaceutical product. Forecast modeling is conducted for two items in each industry, for a total of six items. The EEMD algorithm is intended to examine the demand pattern of a specific item in detail. Therefore, rather than building a model for a group of multiple items at once, it is applied to a single item, so the experiment is conducted using data from a small number of items. The office product is called a product A, the packaging material is called a product B, and the pharmaceutical product is called a product C.

At least one of the indicators among NRMSE, NMAE, and R² can be used to evaluate the performance of the product demand forecasting using a decomposition technique and machine learning hybrid model of the present disclosure. RMSE (Root Mean Square Error) is the square root of the average of the squares of the differences between a predicted value and an actual value. The RMSE is more sensitive to outliers than other accuracy indicators because the square value of residue that amplifies the influence of outliers is used. NRMSE (Normalized Root Mean Square Error), which is obtained by dividing the RMSE by the mean, is expressed in a normalized form and is useful for indicating relative accuracy. The NRMSE is suitable for comparison between data or models, and has the characteristic of not being affected by units, so data of various units can be fairly compared. Therefore, the NRMSE is a model performance measurement indicator that is relatively robust to outliers, and its related expression is as follows [Expression 10].

$$NRMSE = \frac{\sqrt{\frac{1}{N}} {\sum }_{i = 1}^{N} {( {y}_{i} - \hat{y} )}^{2}}{mean ( {y}_{t} )} . \qquad [ Expression 10 ]$$

The MAE (Mean Absolute Error) is an average value of the difference between the predicted value and the actual value. Since this value takes the absolute value, it has the same influence whether the error value is large or small. NMAE (Normalized Mean Absolute Error), which is obtained by dividing MAE by the mean and normalizing it, is used as a relative performance indicator that reduces the influence of outliers without being affected by units, and its related expression is as follows [Expression 11].

$$NMAE = \frac{\frac{1}{N} {\sum }_{i = 1}^{N} \vert {y}_{i} - \hat{y} \vert}{mean ( {y}_{i} )} \qquad [ Expression 11 ]$$

R² (R-Squared) is an explanatory power index that indicates how much the independent variable explains the dependent variable in the regression model. A high coefficient of determination means that the independent variable has a high explanatory power for the dependent variable. R² is one of the important indices for interpreting the regression analysis results and comparing models, and the related expression is as follows [Expression 12].

$${R}^{2} = 1 - \frac{\sum {( {y}_{i} - \hat{y} )}^{2}}{\sum {( {y}_{i} - \overline{y} )}^{2}} \qquad [ Expression 12 ]$$

The NRMSE, NMAE, and R² are used to evaluate and compare the accuracy and explanatory power of the model in various situations without being affected by the unit. Through these indices, the performance of the proposed model can be compared and the effectiveness can be proven.

In the present disclosure, various models were selected and the performance evaluation was performed to verify the validity of the demand forecasting unit 140 using the first model, second model, and third model. In the initial stage, LSTM, ARIMAX, and LGBM single models were set, and the combined model of EEMD and LSTM, the combined model of EEMD and ARIMAX, and the combined model of EEMD and LGBM were introduced. The application of the EEMD increased the performance of each single model and proved the effectiveness of EEMD. Afterward, the additional utility of LASSO was confirmed through a performance comparison between the model combining EEMD and LSTM and the combined model of LASSO, EEMD, and LSTM proposed in this study. Through this process, this study aims to confirm the validity of whether the combination of LASSO and EEMD is a methodology that improves the accuracy of demand forecasting.

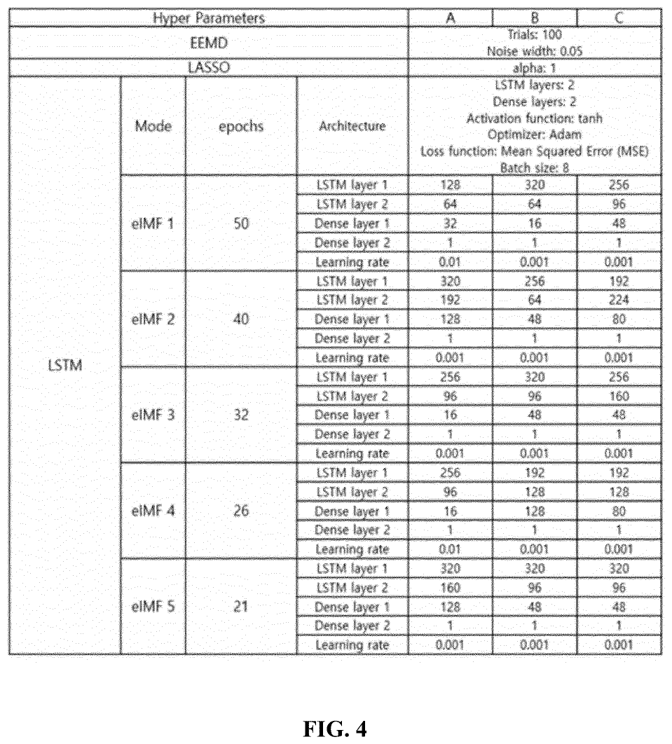

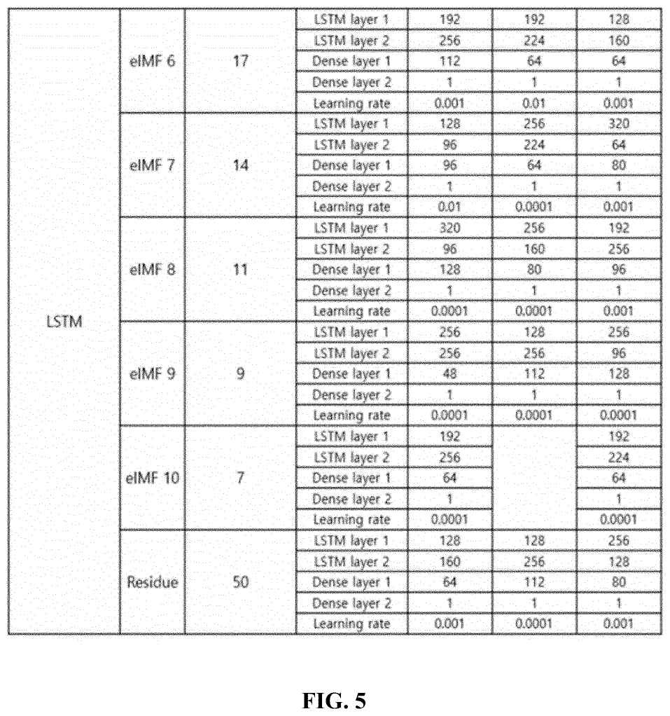

One of the main processes for improving the performance of the demand forecasting unit 140 using the first model, second model, and third model of the present disclosure was hyperparameter optimization. FIGS. 4 and 5 illustrate the optimized hyperparameters. For hyperparameter optimization, a Keras tuner was used to perform a random search to find the optimal hyperparameters for the number of units of an LSTM layer and Dense layer in each eIMF and a learning rate. In this process, the EEMD was performed a total of 100 times, and the standard deviation of noise was set to 0.05 for each cycle. The alpha value, which was a hyperparameter of LASSO, was set to 1. In the random search process, the number of units in the LSTM layer and the Dense layer were set to be different for each eIMF, and each layer was fixed to 2. In addition, “Adam” was selected as the optimizer and “tanh” was adopted as the activation function to verify the performance of the model.

Through this, it is possible to have different hyperparameter combinations for each eIMF, and these various hyperparameter settings contributed to improving the demand forecasting performance of the combined model. Through this optimized hyperparameter setting, the EEMD+LASSO+LSTM combined model proposed in the present disclosure was able to realize more accurate demand forecasting performance than existing models.

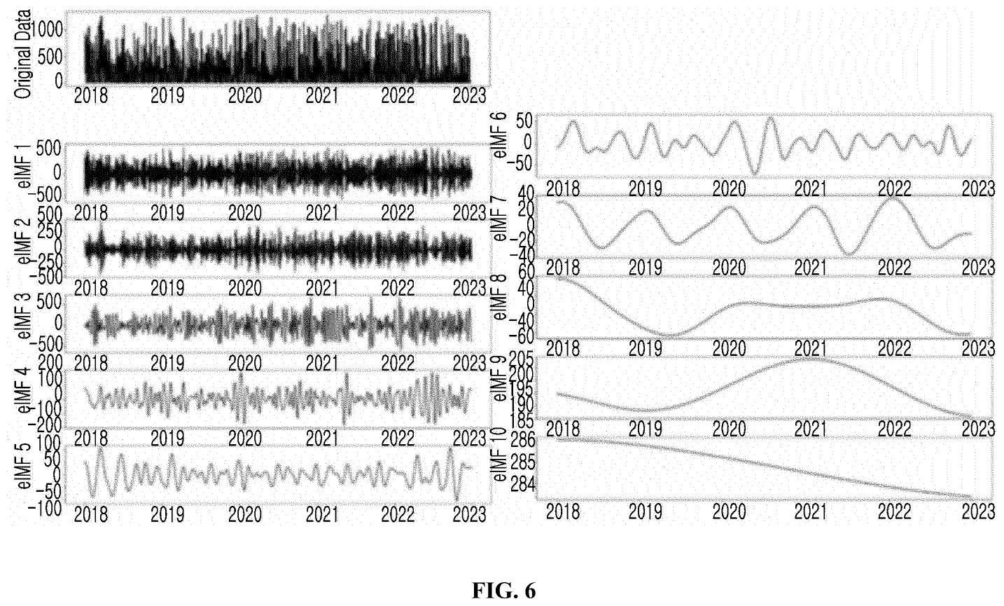

The demand forecasting unit 140 of the present disclosure can perform the demand forecasting using all of the first model using the EEMD algorithm, the second model using the LASSO algorithm, and the third model using the LSTM model. FIG. 6 illustrates the EEMD decomposition result of the office product A performed according to the framework of the EEMD+LASSO+LSTM model of the present disclosure. Referring to FIG. 6, the demand data is decomposed into several eIMFs and residue using the EEMD technique. The EEMD separates the complex nonlinear and non-stationary characteristics of the original time series data into each eIMF, and through this, signals with different frequencies can be clearly distinguished. Since the EEMD takes a method of empirically decomposing the original graph, the number of eIMFs extracted varies depending on the shape of the time series data. The eIMFs obtained as the decomposition result each express time series data with different patterns. Their combination reconstructs the original time series data, and as eIMFs are extracted, the poles are reduced and the eIMF is simplified. Through this process, the simplified eIMFs help LSTM to reflect various characteristics of the original time series data more effectively.

Afterward, the LASSO model was applied to extract key variables for each eIMF. As each eIMF is extracted, the graph is simplified, and accordingly, the number of extracted variables tends to decrease. This is because as eIMFs are simplified, the main patterns or characteristics become clear, and the number of key variables reflected in them decreases.

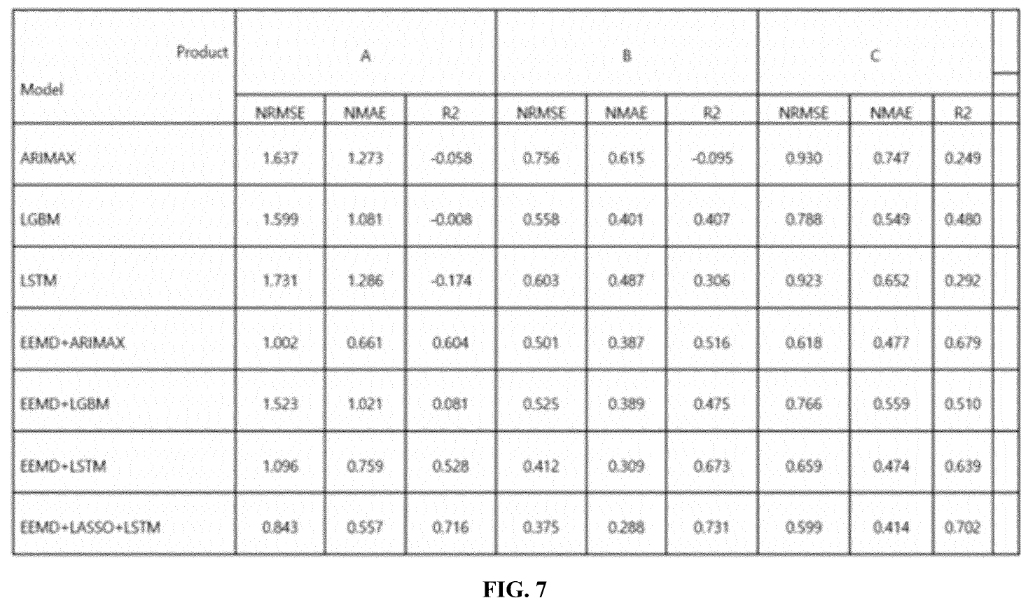

The performance of the six benchmarking models described above and the EEMD+LASSO+LSTM model which is the hybrid model of the present disclosure was measured. The average performance indicators for products from three industries, such as the office product A, the packaging material B, and the pharmaceutical product C, were compared and analyzed. FIG. 7 illustrates the results measured by a total of three evaluation indicators such as NRMSE, NMAE, and R². As a result of the comparison, the model combining EEMD illustrated better performance than a single model. Furthermore, when the LASSO was added to the EEMD combined model to select key variables, it was confirmed that the demand forecasting performance of the model was further improved. That is, compared to a single model, the EEMD+LASSO+LSTM model illustrated high accuracy in the demand forecasting for various product groups such as the office product A, the packaging material B, and the pharmaceutical product C. These results prove that the model proposed in the present disclosure is effective and reliable for demand forecasting in various industrial fields.

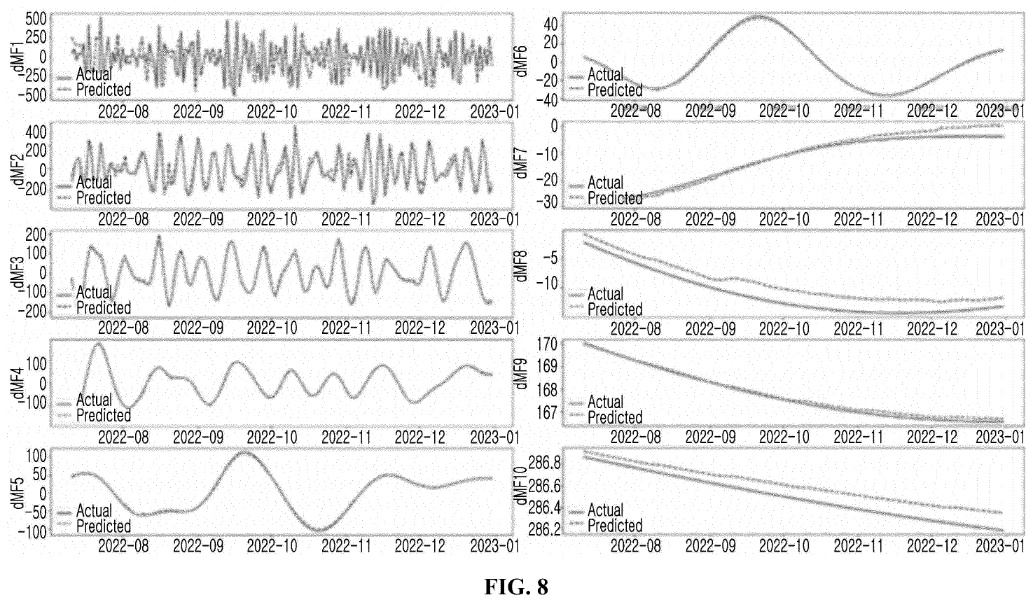

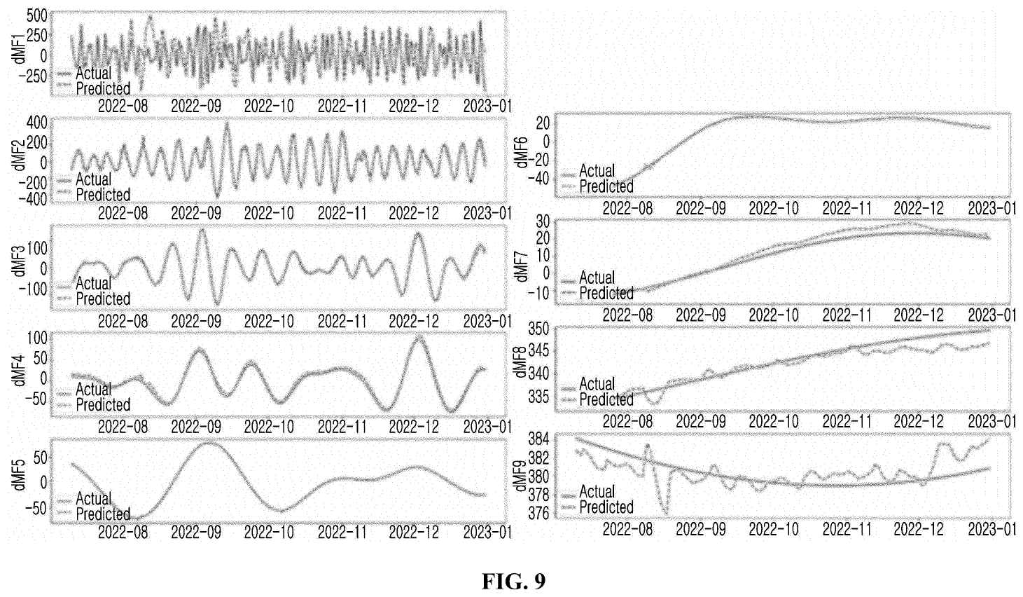

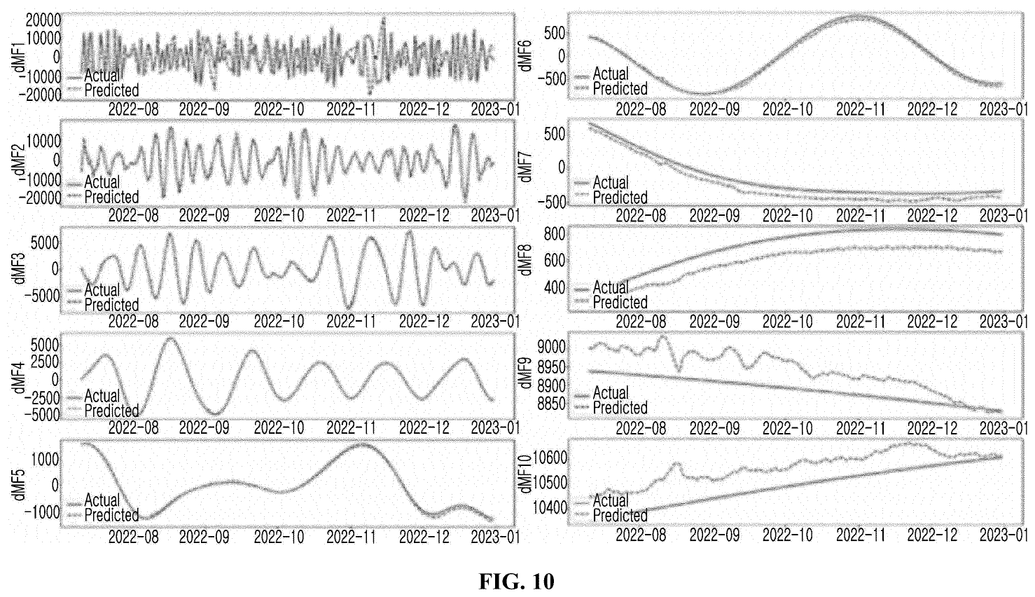

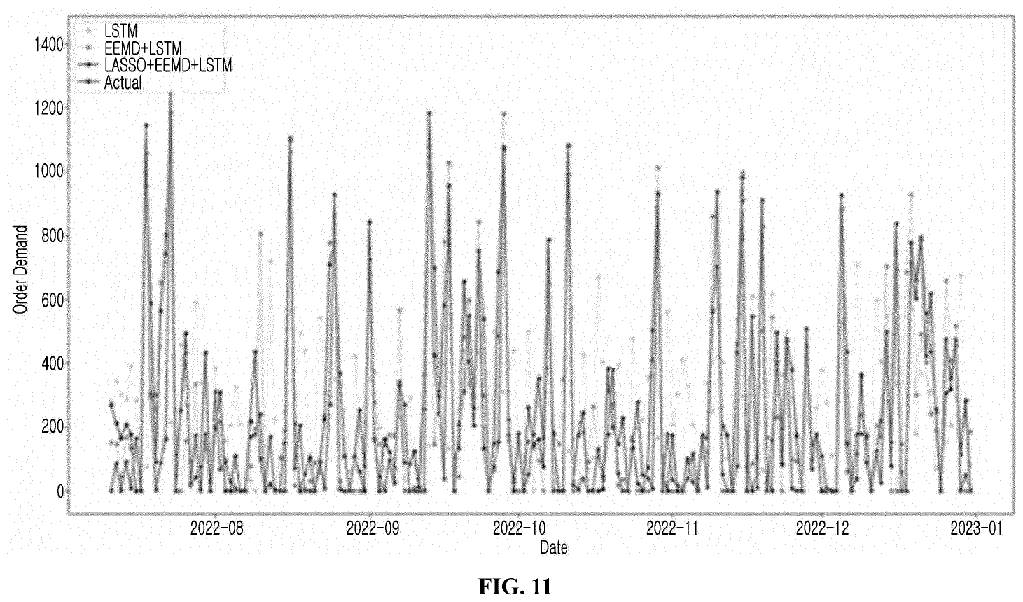

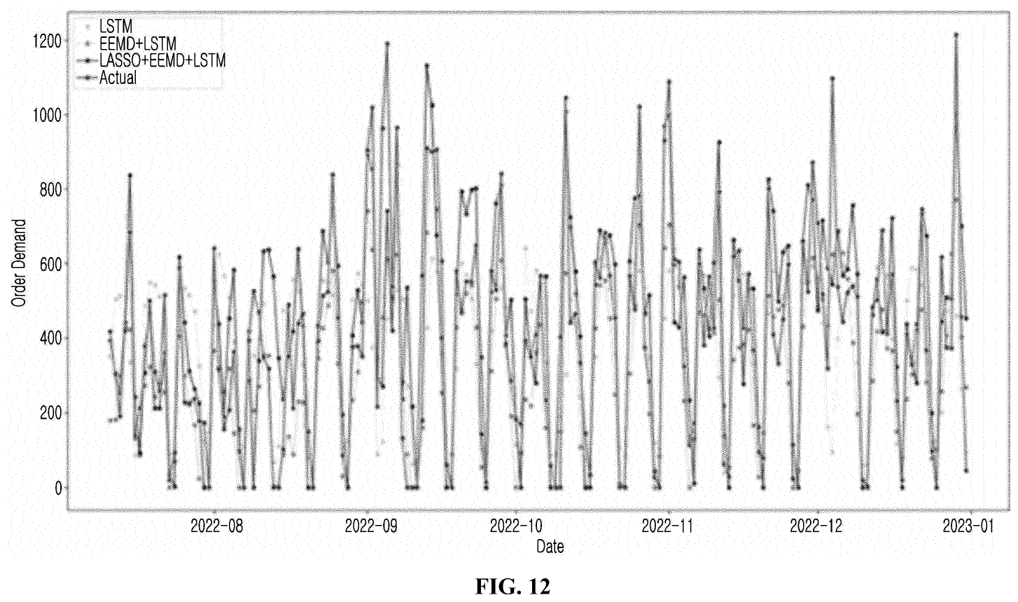

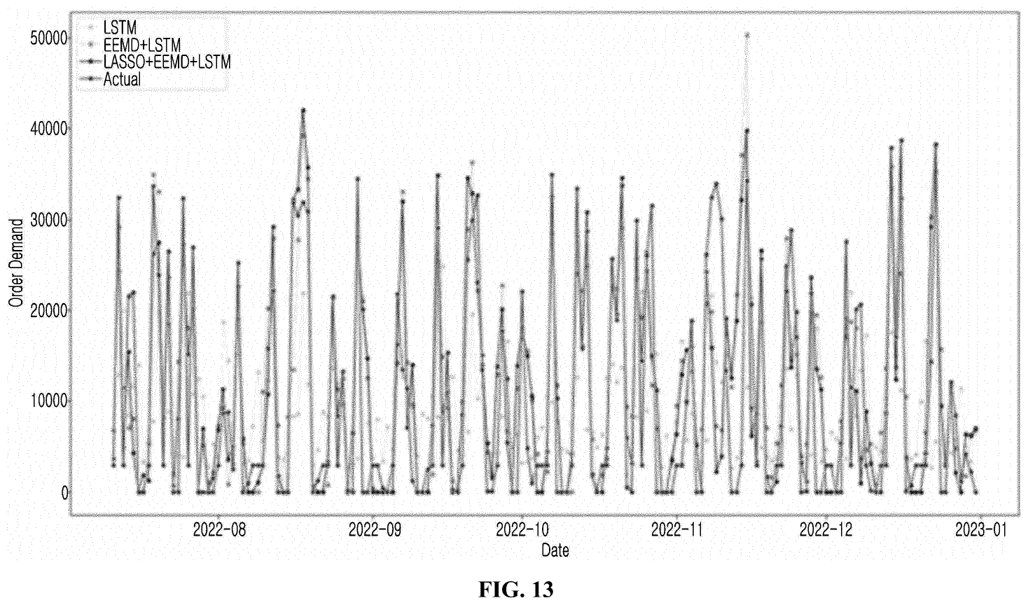

FIG. 8 illustrates an eIMF graph for the office product A, FIG. 9 illustrates an eIMF graph for the packaging material B, and FIG. 10 illustrates an eIMF graph for the pharmaceutical product C. FIG. 11 illustrates a graph of predicted and actual value of the office product A, FIG. 12 illustrates a graph of predicted and actual values of the packaging material B, and FIG. 13 illustrates a graph of the predicted and actual values of the pharmaceutical product C. Referring to FIGS. 8 and 9, it can be seen that the graph tends to become simpler as eIMF is decomposed, and that the empirical decomposition process is an important factor in improving forecast performance. In addition, it can be seen that adding the predicted values of each eIMF effectively contributes to the demand forecasting of the product. FIGS. 11 to 13 illustrate comparison graphs of LSTM, EEMD, and Lasso combined models.

The disclosure has been described with reference to the embodiments illustrated in the drawings, but these are merely exemplary, and those skilled in the art will understand that various modifications and equivalent other embodiments are possible from this. Accordingly, the true technical protection scope of the present disclosure should be determined by the technical idea of the attached registration claims.

What is claimed is:

1. A method for controlling production lines based on a product demand forecasting using a decomposition technique and a machine learning hybrid model, wherein a processor and one or more memory devices communicatively coupled to the processor, and the one or more memory devices stores instructions operable when executed by the processor to perform:
constructing a first model that decomposes time series data into at least one ensemble Intrinsic Mode Functions (eIMF) and a residual based on a decomposition algorithm including at least one of Ensemble Empirical Mode Decomposition (EEMD), Empirical Mode Decomposition (EMD), and Complete Ensemble Empirical Mode Decomposition (CEEMDAN);
constructing a second model that extracts a key variable from the eIMF based on a Least Absolute Shrinkage and Selection Operator (LASSO) algorithm including at least one of Elastic-net, Ridge, and SHapley Additive explanations (SHAP);
constructing a third model that performs demand forecasting by inputting the key variable into a machine learning model;
inputting original data into the first model to decompose the original data into at least one eIMF and a residual;
inputting the eIMF decomposed in the first model into the second model to extract the key variable;
inputting the key variable extracted from the second model into the third model to forecast demand; and
transmitting a control signal to the production lines, such that a production volume of at least one product is directly controlled, in real time, based on the forecasted demand,
wherein
the original data is time series data in which preprocessing and feature engineering of product demand data have been performed in advance, and is data prepared for model learning by extracting product demand data by item for time series modeling, and
the first model:
sets the number of ensembles and a standard deviation of white noise which is to be added to the time series data;
generates a signal with added noise obtained by adding white noise to the time series data according to the set number of ensembles;
extracts at least one IMF from each signal with the added noise;
calculates an average of the extracted IMFs and extract the average as the eIMF; and
extracts a difference between the time series data and the eIMF as the residue.

2. An apparatus for controlling production lines based on product demand forecasting using a decomposition technique and a machine learning hybrid model, the apparatus comprising:
a processor; and
one or more memory devices communicatively coupled to the processor, wherein the one or more memory devices stores instructions operable when executed by the processor to perform:
constructing a first model that decomposes time series data into at least one ensemble Intrinsic Mode Functions (eIMF) and a residual based on a decomposition algorithm including at least one of Ensemble Empirical Mode Decomposition (EEMD), Empirical Mode Decomposition (EMD), and Complete Ensemble Empirical Mode Decomposition (CEEMDAN);
constructing a second model that extracts a key variable from the eIMF based on a Least Absolute Shrinkage and Selection Operator (LASSO) algorithm including at least one of Elastic-net, Ridge, and SHapley Additive exPlanations (SHAP);
constructing a third model that performs demand forecasting by inputting the key variable into a machine learning model;
inputting original data into the first model to decompose the original data into at least one eIMF and a residual;
inputting the eIMF decomposed in the first model into the second model to extract the key variable;
inputting the key variable extracted from the second model into the third model to forecast demand; and
transmitting a control signal to the production lines, such that a production volume of at least one product is directly controlled, in real time, based on the forecasted demand,
wherein
the original data is time series data in which preprocessing and feature engineering of product demand data have been performed in advance, and is data prepared for model learning by extracting product demand data by item for time series modeling, and
the first model:
sets the number of ensembles and a standard deviation of white noise which is to be added to the time series data;
generates a signal with added noise obtained by adding white noise to the time series data according to the set number of ensembles;
extracts at least one IMF from each signal with the added noise;
calculates an average of the extracted IMFs and extract the average as the eIMF; and
extracts a difference between the time series data and the eIMF as the residue.
